(19) United States
(12) Patent Application Publication
(10) Pub. No.: US 2022/0125078 A1
(43) Pub. Date: Apr. 28, 2022

(54) Freeze Drying Methods

(71) Applicant: Harvest Right, LLC, North Salt Lake, UT (US)

(72) Inventors: Dale Porter, South Jordan, UT (US); Daniel D. Neville, Fruit Heights, UT (US); Rex C. Haddock, Bountiful, UT (US)

(21) Appl. No.: 17/303,761

(22) Filed: Jun. 7, 2021

Related U.S. Application Data
(63) Continuation-in-part of application No. 16/659,259, filed on Oct. 21, 2019.
(60) Provisional application No. 63/039,377, filed on Jun. 15, 2020.
(60) Provisional application No. 62/705,002, filed on Jun. 5, 2020.
(60) Provisional application No. 62/748,247, filed on Oct. 19, 2018.

(51) Int. Cl. A23L 3/44; A23L 3/015

(52) U.S. Cl. CPC A23L 3/44; A23L 3/0155

(57) ABSTRACT

A freeze drying method including vacuuming freezing food, confirming operational status of at least one of a pressure sensor, a temperature sensor, a heating system, a cooling system, and/or a vacuum pump, and/or performing at least one of pre-frozen or not frozen status check, a chamber pre-freezing process, a vacuum leak check, a drying process, a final dry process, including any of such processes described in the specification.

### TECHNICAL FIELD

This relates to freeze drying methods and apparatuses. It especially relates to methods used by a controller to operate a freeze dryer.

### BACKGROUND

Conventional freeze-drying, or lyophilization, involves freezing a material, placing it in a chamber at a temperature and pressure below the triple point of water (32.018° F. and 4588.35 mTorr), and removing the water by sublimation.

Freeze-drying results in a high-quality product because of the low temperature used in processing. The original shape of the product is maintained, and the quality of the rehydrated product is excellent. Primary applications of freeze drying include biological (e.g., bacteria and yeasts), biomedical (e.g., surgical transplants), pharmaceutical, herbal and cannabis applications, as well as food processing (e.g., coffee) and preservation.

Although conventional freeze-drying processes provide numerous advantages, they also suffer from a number of problems. One problem is that the freeze-drying process is slow and can take days to complete. Another problem is that different materials respond differently to being freeze dried. This makes it difficult to provide a single process and/or apparatus that is suitable for freeze trying a wide range of materials.

### DRAWINGS

The preferred and other implementations are disclosed in association with the accompanying drawings in which:

FIG. 1 is a graph showing the freezing time for four different products. The x axis of the graph is time in minutes and the y axis is the temperature of the product.

FIG. 2 is a graph showing vacuum pressure in mTorr over time in minutes at the top and temperature in F over time at the bottom.

FIG. 3 is a graph similar to that shown in FIG. 2 except it is for a small and/or low moisture batch.

FIG. 4 is a graph showing an enlarged section of the graph in FIG. 2.

FIG. 5 is a graph showing the end portion of the graph in FIG. 2.

### DETAILED DESCRIPTION

A number of freeze-drying methods and freeze-drying apparatuses (also referred to as freeze dryers, freeze drying units, or freeze dryer units) are described. The methods and apparatuses are generally described in the context of freeze-drying food. It should be appreciated, however, that they can also be used in other contexts such as medical applications, pharmaceutical applications, laboratory applications, and the like.

### Freeze Dryer Apparatus

The freeze drying apparatus can be any of those described in the documents incorporated by reference at the end of this document. The following methods can be implemented by the controller (e.g., processor with software) used to operate the freeze drying apparatus. For example, the methods can be implemented as software or firmware for a freeze dryer.

### Confirm Operational Status of Sensors

In some implementations, the controller may be configured to test and verify that the temperature and vacuum pressure sensors are working before starting freeze drying material or as part of the process of the process of freeze drying material—e.g., the controller verifies the sensors that control the freeze-drying process work before starting the freeze drying process. The following are some examples of tests the controller may run to determine the operational status of the sensors.

Pressure Sensor Test

The purpose of this test is to confirm that the one or more pressure sensors in the chamber of the freeze dryer are fully functional and operational and read properly. Before the vacuum pump is turned on, the pressure in the freeze dryer is at atmospheric pressure. The pressure sensor should show the pressure as being consistent with atmospheric pressure.

The pressure sensor can be tested in a variety of ways to determine whether they are good. For example, the pressure as determined by the sensor can be compared to one or more criteria indicating it is good. In some implementations, the pressure sensor is determined to be good if it reads above a certain value such as 2500 mTorr (atmospheric pressure is approximately 760 Torr). In other implementations, the pressure sensor is determined to be good if it reads 635 Torr to 815 Torr.

The pressure sensor can be tested once, multiple times, or continuously before the vacuum pump is turned on. Testing more often or continuously makes it possible to confirm the pressure sensor is functional right up to the point the vacuum pump is turned on.

Temperature Sensor Test

The purpose of this test is to confirm that the one or more temperature sensors (e.g., thermistor) in the freeze dryer are fully functional and operational and read properly. In some applications, if a temperature sensor is not working properly, it will show a reading of −70° F. or below. If the temperature reads warmer than this, then the temperature sensor is determined to be functional and operating within a normal operating range. The temperature sensors can be tested in this and other manners to confirm that the shelving unit is connected to power and the temperature sensors are detecting temperature.

It should be appreciated that the criteria used to test the temperature sensor can vary depending on the configuration and properties of the temperature sensor. For example, another temperature sensor may work differently and may show a different reading when it is faulty.

Heater Test

The purpose of this test is to confirm that the one or more heaters in the freeze dryer are fully functional and operational. This test establishes the performance of the heaters prior to freeze drying a batch of material. It should be appreciated that the test can use a variety of criteria to determine the heater is functioning properly.

In one implementation, the test includes confirming the heater is powered on and/or capable of raising the temperature of the shelf by at least 2° F. The test can also be used to confirm that the temperature sensor is registering the change in temperature.

In one example, the test includes turning on the heaters for 10 seconds and waiting up to 30 seconds to detect a 2° F. rise in temperature. If the temperature rise is not detected, then it repeats the process. If it still does not detect a rise in temperature, the heaters are turned on for up to two minutes. If it still does not detect a rise in temperature, then the controller displays a message on the screen stating the heaters are not working.

Cooling Test

The purpose of this test is to confirm that the condensing unit is fully functional and capable of cooling the chamber of the freeze dryer. It should be appreciated that this test can use a variety of criteria to determine whether the cooling system and/or the condenser unit is capable of cooling the chamber.

In one implementation, the test is used to confirm that the cooling system can reduce the temperature in the chamber during the first 15 to 40 minutes of operation. When the food/material is placed on the trays, the heat from the trays is conducted to the shelf where the temperature sensors are located. It typically takes 15 to 20 minutes for the shelf temperature to equalize with the tray temperature. The chamber is actively cooled while the tray temperature and the shelf temperature equalize. After the tray and shelf temperatures have equalized (e.g., after 15 to 20 minutes), the controller verifies that the temperature of the shelf over next 20 minutes continues dropping.

In one implementation, this is accomplished by taking a temperature reading every 5 minutes. Each 5-minute period should see a change in temperature that is equal to or lower than the previous 5 minutes. If it sees such a drop, then the cooling system and/or the condensing unit is operating properly. If the unit has been in the pre-freeze mode prior to loading the trays, the test runs without trays and verifies during a 15 to 20 minute period that the temperature is dropping.

Vacuum Pump Test

This test is used to analyze the performance of the vacuum pump prior to or during the vacuum freeze process and/or the drying process when the vacuum pump powers on. The system has a pressure sensor that is used to measure the change in pressure every 3 minutes. Each pressure reading is compared to the prior pressure reading. If the pressure goes up instead of down, the system sends a message to the screen reporting that there is a vacuum failure. Once the pressure goes below 2500 mTorr, the test is suspended. After this test is run, there are other vacuum tests that determine the vacuum pressure is getting low enough to begin the freeze drying process.

### Pre-Frozen or Not Frozen Product Status Check

The product being freeze dried can be supplied as pre-frozen or not frozen. The user inputs whether the product is pre-frozen or not frozen before beginning the freeze drying process. When frozen is selected, the refrigeration condenser begins cooling and the user is prompted to insert their material. When pre-frozen is selected the refrigeration condenser begins cooling and the user is told to not insert their material until they are prompted to do so when the shelf unit thermistor measures 32 degrees F. Regardless of what process the user selects, the condition of the product is verified by the controller as it analyzes the temperature readings coming from the shelf thermistors.

When trays of food/material are placed into the freeze dryer, the unit determines if and when the product is ready to advance from the freeze process to the vacuum freeze process and/or to the dry process by analyzing the temperature of the shelves the trays are resting on (the shelves have thermistors or other devices that sense/measure temperature). Because the trays are touching the shelf, the tray temperature is conductively transferred to the shelf thermistor which measures the change in temperature.

If trays of non-frozen material are placed in the freeze dryer, the thermistors sense that the material is relatively warm and continues with the freeze process until the unit determines that the material has frozen to a low temperature (for example: 5° F.). At this point, the system can be configured to automatically proceed to freeze it even colder through the vacuum freeze process. Once the system determines the temperature is very cold (for example: −30° F.) the vacuum dry process begins. Details of this process are described in the patent application titled “Vacuum Freezing Methods and Apparatuses,” which is incorporated by reference at the end of this document.

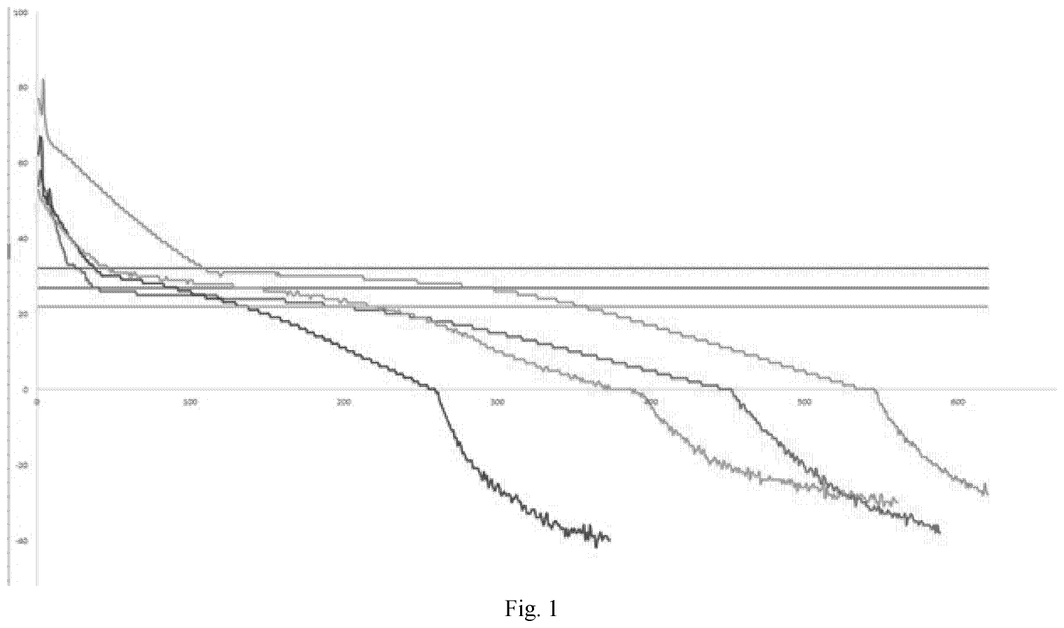

Testing has revealed that freezing food/material from ambient temperature to 32° F. is a relatively quick process (see FIG. 1). However, cooling it to a temperature of roughly 27° F. to roughly 21° F. takes more time. After it reaches this temperature range, the speed of cooling accelerates.

If trays of pre-frozen material are placed in the freeze dryer the shelf thermistors measure the temperature and determine that the material is already frozen (usually at a temperature of 27° F. to 21° F.). Because heat is conducted between the trays and the shelf thermistors, the controller analyzes the rate the temperature of the shelf changes after the trays of material have been placed on shelves. For example, the unit might sense that the shelf temperature dropped from 40° F. to 21° F. in 15 minutes. Because the temperature dropped so quickly, the system determines that the food is frozen and that it can immediately move to the vacuum freeze process. This analysis allows the system to shorten the entire freeze dry process by skipping hours of unnecessary freeze time. Again, by using the rate of temperature change recorded by the shelf thermistors, the unit can determine if the food is completely frozen and if it is ready to be advanced to the next process.

The controller can use a variety of criteria to determine whether the material is pre-frozen. In one implementation, the status of the food is determined to be pre-frozen if the temperature of the shelf drops at least as fast as a specified rate—e.g., 8° F. drop in 15 minutes (but must reach a temperature of between 27° F. or lower).

During the vacuum freeze process the food/material gets much colder, cold enough to begin a successful freeze dry process.

Temperature sensing and reporting is beneficial in order to determine the amount of time needed while in the freezing phase. If the product is not frozen long enough, the center may remain unfrozen. This may cause the material being dried to collapse as too much water is too quickly sublimated from the product. The other drawback from vacuum drying without the product being frozen adequately is that instead of the water collecting and refreezing on the sides of the chamber, the large amounts of sublimated water vapor may overwhelm the collection chamber and may be sucked into the vacuum pump. This reduces the efficiency of the vacuum pump and could even damage it by causing it to rust and corrode.

As the product freezes from the outside inward, there is a transition period before the inner core achieves a frozen state. This is similar to the way ice cubes are formed. The outside solidifies first while the center remains in a liquid state. Over time the thickness of the outer portion increases and heat is transferred from the inside out, until the water solidifies throughout. While this solidification of water thickens and the heat transfer occurs, the temperature of the outside drops slowly. Once the core of the ice cube or water-based material is completely solid, the temperature of the product will drop at an accelerated rate. For example, when freezing a tray filled with water, the temperature dropped as follows. This data will vary based on product density, thickness, molecular structure and so on.

Standard Freeze Process

75° F. to 32° F., took 80 minutes (−0.54° F./minute or −1° F. in 1:52 minutes average) 32° F. to 27° F. took 85 minutes (−0.06° F./minute or −1° F. in 17:00 minutes average) 27° F. to 21° F. took 43 minutes (−0.14° F./minute or −1° F. in 7:10 minutes average) 21° F. to 0° F. required 61 minutes (−0.34° F./minute or −1° F. in 2:54 minutes average)

Vacuum Freeze Process

0° F. to −20° F. required 16 minutes (−1.25° F./minute or −1° F. in 0:48 minutes average) −20° F. to −34° F. required 31 minutes (−0.45° F./minute or -1 ° F. in 2:13 minutes average)

As described previously, one such example is that if the temperature of the shelving unit is 40° F. and then the trays with frozen food/material are loaded onto the shelving unit, the temperature sensor (thermistor) measures an accelerated drop in temperature. If the temperature drops quickly to a temperature of 27° F. to 21° F. within a few minutes, the system may determine that the product is ready to advance to “vacuum pump on” freeze or dry status. Similarly, if the temperature of a pre-frozen batch does not drop quickly to 21° F. but does drop to a low temperature such as 5° F. within 1 hour, a determination may be made that it is also frozen and ready to advance to vacuum freeze. The controller (firmware) performs multiple tests. It tests for a drop in temperature to 27° F. or lower within 15 minutes of putting the material in the freeze dryer. And, if that criteria is not met, it also tests to see if the material drops to 10° F. or lower within a certain time range (such as an hour). If one of the tests is successful, it will determine that the material has been pre-frozen and is ready to begin vacuum freeze. Alternatively, if the temperature of a batch is not sensed as dropping quickly enough, the unit will determine that the food/material is not frozen and will continue freezing as normal until the food/material reaches a very low temperature such as 0° F. before beginning the vacuum freeze process or the dry process.

The graph in FIG. 1 shows how a number of different materials freeze. Again, different water-based materials may freeze differently based on thickness, density, chemical and molecular structure. In FIG. 1, the time is shown in minutes (0 to 600 minutes) on the x axis, which is the horizontal black line in the middle of the graph. The graph represents the freezing process and time for 4 different materials. By looking at just the topmost line, it is apparent that the time to cool to 32° F. was fast while cooling from 32° F. to 21° F. took much longer (this is mainly due to the significant amount of latent heat removed as the water changes phase from a liquid to a solid). In some implementations, the following information is used by the controller to determine if something has been pre-frozen. For example: If, in a few minutes (i.e., 15 or 20 minutes) the temperature of the trays touching the shelf are sensed to drop to less than 25° F. the controller will determine that the material has been pre-frozen and proceed to the vacuum freeze process. In comparison, something that is not pre-frozen may take 40 minutes or longer to reach 25° F.

### Chamber Pre-Freezing Process

In those situations where frozen food or material is placed in the freeze dryer it is beneficial to cool the chamber of the freeze dryer to at least 32° F. prior to loading the food/material. The freeze dryer can include a pre-freeze option or button that turns on the refrigeration condenser and then notifies the user (on the screen) when it is time to put the frozen food/material in the chamber to be freeze dried. This notification occurs when the chamber is 32° F. or colder so that the material placed in the freeze dryer chamber doesn't defrost.

If the refrigeration condenser runs for a long period of time, it may cause the chamber to get so cold that the temperature sensors do not correctly read the temperature of the food trays when they are placed in the chamber. The temperature sensors may mistakenly measure the temperature of the material/food as being colder than it is. If this happens, the dry process may begin prematurely because the temperature sensor is sensing how cold the chamber and shelves are, not how cold the food/material is. When this happens and the material is not adequately frozen, the heaters turn on and the system may experience a runaway sublimation process as the less than frozen water quickly boils and overwhelms the ice collection process as well as the vacuum pump.

The controller can be configured to address this problem as follows. The system monitors the temperature of the shelves. When they reach 32° F., the system notifies the user that it is ready to put the frozen material into the chamber. If the user does not put the food/material in at that time the system allows the freezing to continue until the temperature of the shelves reaches a lower threshold temperature such as 20° F. At that point, the refrigeration condenser is turned off until the temperature rises to an upper threshold temperature such as 30° F., whereupon the freezer turns back on and continues the cycle until the user puts the food/material in the chamber and presses continue. This keeps the chamber from getting so cold that it can't sense the temperature of the food/material being frozen.

It is desirable to sense the temperature of the material or food that is being placed in the chamber because it is possible that a user could have selected the pre-frozen cycle when the food is not frozen. In that situation the unit will (usually within 15 to 20 minutes) detect a rise in temperature. When this occurs, the freeze dryer will simply freeze the material as if it was not pre-frozen until it gets down to a lower temperature so that the vacuum freeze process can begin.

### Vacuum Leak Check

The system checks for vacuum leaks to verify that the vacuum pump is connected properly (hoses fit connections tightly) and also to verify that the door is securely latched and sealed and the drain valve is properly closed. If the system detects a vacuum leak, it will prompt the customer to check for each of these conditions. When the vacuum pump is initially powered on, the controller checks every 3 minutes to insure that the pressure is going down. If it is not going down and if the freeze dryer's vacuum pump is not able to pull a vacuum to 2,500 mT or lower, the controller determines that there is a vacuum leak in the freeze dryer or between the vacuum pump and the freeze dryer. This may also suggest that the vacuum pump is not powered on or is not functioning properly. In order to proceed, all of these scenarios will need to be checked.

Adjust Process to Vacuum Pump Capability

The controller verifies that the vacuum pump is working properly and/or adjusts the process to accommodate a poor performing vacuum pump. If the pump performance is subpar the limits and ranges of vacuum pressure for sublimation are altered to allow the product to be freeze dried anyway.

Vacuum pumps are usually strong when they are new. As they get older, they lose some of their vacuum power. Based on the vacuum pressure, the freeze-drying process includes turning the heaters on and off to dry the food. When the vacuum pressure is lowered to 500 mTorr (or lower) the unit turns the heaters on causing sublimation of water from the material being freeze dried. The sublimation increases the pressure in the chamber as water vapor is released from the food.

With this in mind, some implementations of the process work as follows:
When the food/material is adequately frozen to begin the dry process, the vacuum pump turns on and pulls a low vacuum (such as 500 mTorr or lower).
The heaters beneath the trays of food/material turn on and warm the food causing sublimation, which increases the pressure in the chamber.
When the pressure reaches a high limit (such as above 600 mTorr), the heaters turn off.
The water vapor that sublimated from the drying food/material then freezes to the wall of the chamber or water collection device. This, in turn, also reduces the pressure in the chamber to a lower threshold (such as 500 mTorr).
At this point, the heaters turn back on and begin the sublimation cycle again.

The power of the vacuum pump may diminish, especially as it gets older. The controller can be used to determine the vacuum pump's capability and predict the pressure range for optimal sublimation. For instance, an older vacuum pump might not be capable of reducing the pressure to 500 mTorr, but can reduce the pressure to 700 mTorr. In this case, the system automatically adjusts the drying cycle from 500 mTorr/600 mTorr to a higher-pressure range, say 700 mTorr/800 mTorr.

The unit can test the strength of the vacuum pump when it is in the vacuum freeze mode or at the beginning of the dry mode (prior to turning on the heaters and beginning sublimation). This can then be used to set the target pressure of a batch when it is dry.

In order to accomplish the above, the controller can use an algorithm to advance from vacuum freezing (vacuum is on and pulls as low as it can) to drying based on time/pressure/temperature readings. The controller keeps a running average of the vacuum pressure for a stabilized analysis. As the drop in vacuum pressure begins to slow, the system recognizes that the pump is nearing its capability. At this time, during vacuum freeze, when the temperature has dropped to an adequate level (i.e., −20° F. or thereabouts) and the vacuum has achieved an adequate level (below 500 mTorr) and the drop in pressure slows (i.e., 5 mTorr drop over a one-minute time period) the system advances to begin the vacuum drying process. If vacuum freeze is not used as part of the process, the same process takes place. During the freeze cycle/process, the material being freeze dried must become quite cold, generally lower than 0° F. Once the predetermined cold temperature has been reached for a certain amount of time (to ensure that it really is that cold all the way through the center of the material) the vacuum pump turns on and pulls a vacuum. The controller then measures the vacuum pump's ability to pull a deep vacuum and adjusts the drying cycle pressure ranges to accommodate the vacuum pumps capability. For instance, it might be ideal to have the heaters warm the frozen material/food at 500 mT until it reaches 600 mT then shut off until the sublimated vapor has frozen to the walls of the ice collection chamber thus causing the pressure to drop back to 500 mT where this cycle starts again. However, if the vacuum pump is a little weak the controller will sense that and adjust the freeze drying cycle to something a little higher (i.e., 700 mT to 800 mT), this being some range that the vacuum pump is capable of.

### Final Dry Process

As a batch nears the end of drying process, continuing to apply heat based upon the same pressure ranges may cause some products to collapse. This happens when the center of the frozen product gets too warm and melts. Too much heat applied too fast causes the ice at the core of some products to melt into a liquid. The rate of sublimation may weaken the product structure of the food/material being freeze dried causing it to collapse and shrink. At this point it can become chewy and may lose some of its nutrition.

The controller monitors and regulates the amount of heat that is allowed to affect sublimation during the drying process and at the end of the batch during the final dry portion of the process. The controller, through the application of heat, can cause changes the vacuum pressure as sublimation increases or decreases. The controller does this by reducing or increasing the heat and follow-on sublimation so as to manage the vacuum pressure.

Appropriate management of sublimation reduces the stress on the product structure. This prevents the food/material from collapsing from too fast, too much sublimation. The sublimation of the material is controlled so as to gradually and continuously sublimate the outside edges of the frozen material until it is finally able to sublimate the center/core without overwhelming the water collection capability of the chamber and without overwhelming the vacuum pump with too much water vapor.

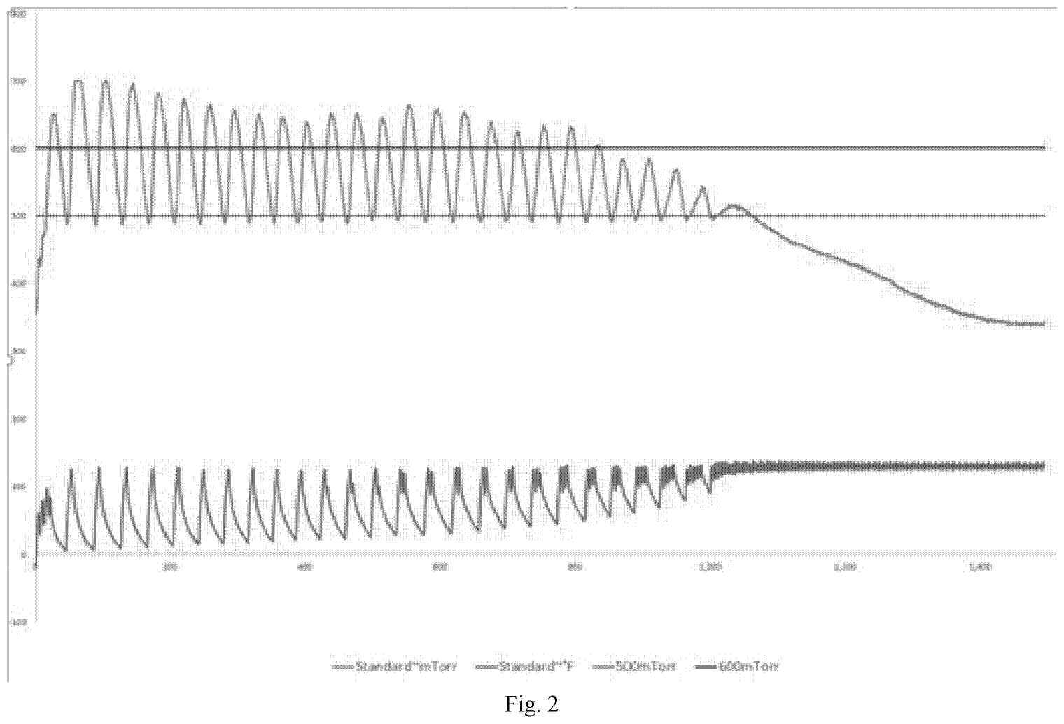

For example, in the graph shown in FIG. 2, the heaters turn on when the vacuum goes below 500 mTorr. When the ensuing sublimated pressure reaches 600 mTorr the heaters turn off. As shown in FIG. 2, the pressure coasts above 600 mTorr until the water vapor freezes to the chamber walls and the pressure drops below 500 mTorr. When this happens, the heaters are turned on and the cycle begins again. As the batch progresses it begins to require more heat or heater cycles to go above 600 mTorr. Eventually the heater cycles are not able to reach 600 mTorr or even 500 mTorr. At this point, the controller is configured to not apply too much heat; because, in later stages too much heat will cause the core of the frozen material to completely melt and collapse. As shown in FIG. 2, the pressure goes down until it levels off around 300 mTorr. It is important during these later stages that the freeze dryer manage the cycles of heat on and heat off correctly.

The top portion of the graph in FIG. 2 represents vacuum pressure along with heater on and off cycles. At the beginning of the process, the cycles are largely kept between 500 mTorr and 600 mTorr until there isn't enough water in the material to increase the pressure. The final pressure ends up being close to the same as it was before the heaters were used to cause sublimation.

The bottom graph in FIG. 2 represents the temperature that the heater reaches in each of the heater cycles. As shown in FIG. 2, at the end, the heat is fairly constant as it doesn't have the peaks and valleys that it did in the beginning. Once the tray temperature reaches a predetermined setpoint (i.e., 125° F.) then the heaters shut off for a specified time (i.e., three minutes) and then the heaters turn on again until they reach the same setpoint (i.e., 125° F.). Then the heaters shut off again for a specified time (i.e., three minutes). This process is repeated over and over. During the specified time that the heaters are off (i.e., three minutes) the temperature and the pressure will drop. This method creates a way for the core of the material that still has ice in it to not melt to and collapse as well as to not get too hot and potentially burn. Another way to accomplish the same thing is to use a constant amount of adjustable heat at a lower range (heaters just stay on, they don't turn on and off) to keep the material/food from collapsing and burning.

### Detect and Adjust Process for Small or Low Moisture Batches

The controller can also be configured to automatically detect when a small or low moisture batch is being processed and subsequently adjust the processing cycle to more effectively and efficiently freeze-dry the batch.

The small batch (low moisture) process is as follows. When the system transitions from the freezing process to the drying process, the system slowly and incrementally applies heat to the frozen product. As the heat is applied, the system monitors the change in vacuum pressure as a result of heat being applied. If over a period of time, a predetermined amount of heat (i.e., the shelf temperature reaches 125° F.) is not able to drive the pressure beyond a certain level (i.e., 600 mTorr or some other preselected vacuum pressure), the system determines that the product or amount of product may require an alternate freeze-drying method. This include adjusting the heater on and off pressure points as well as the way heating cycles are used. These drying cycle adjustments are made to optimally dry the product without damaging the texture and reducing the nutritional state of the material.

One method for drying small batches is to have a single heater “On” and “Off” point. To understand the difference between this and the standard method, they are both described as follows: The standard drying cycle method controls heat-cycles, by monitoring the vacuum pressure in relation to an “On” pressure point and a different “Off” pressure point. The process allows the heaters to be turned on when the pressure drops below the heater “On” point (e.g., 500 mTorr). As heat is applied and the product begins to sublimate, the vacuum pressure rises. The heaters may remain on until the vacuum pressure exceeds a certain heater “Off” point (e.g., 600 mTorr). Once the vacuum pressure exceeds the heater “Off” point, the heaters are turned off and not turned back on until, the pressure drops below the heater “On” point pressure level. The standard drying cycle process continues until the heater cycles are not able to drive the vacuum pressure above the heater “On” point and then the Final Dry process is started.

Conversely, the small (low moisture) batch drying cycle method is as follows: When drying small batches/low water content batches, the heaters along with the water being sublimated are not able to push the pressure up to the 600 mTorr threshold during the initial heater ramp up cycles. When this occurs, the controller determines that the batch should be run using the small batch/low water content process. This process uses a single pressure point. It dynamically determines the “On” pressure point and “Off” pressure point. The “Off Pressure point is set as the highest pressure (or to some point that is slightly lower than the highest pressure) that was achieved during the initial incremental heat warmup phase of the drying process. The “On” pressure point is calculated to be a set point lower than the “Off” pressure point. Once the new drying “On” and “Off” points are calculated, the heaters turn on when the pressure drops below the “On” point. As the pressure rises above the “On” point, the heater may remain on until the pressure reaches the “Off” point or until it is turned off by another process such as the following: once the system determines a maximum chamber sublimation pressure that can be reached when the heaters turn on during the initial drying process, the heaters can then be turned on until they reach a predetermined set point (i.e., 125° F.) whereupon they are turned off for three minutes (or some other predetermined time). And/or, the heaters can be turned on until the sublimated vacuum pressure reaches a predetermined threshold that is based on the initial heater on process. This will only be used when the standard sublimation cycles can't be used because there isn't enough frozen water in the material/food to reach the cycle set point of 500 mTorr to 600 mTorr (or whatever has been predetermined as a standard sublimation drying cycle). This single pressure point method continues until the heater cycles are not able to drive the vacuum pressure above the heater “On” point and then the Final Dry process is started.

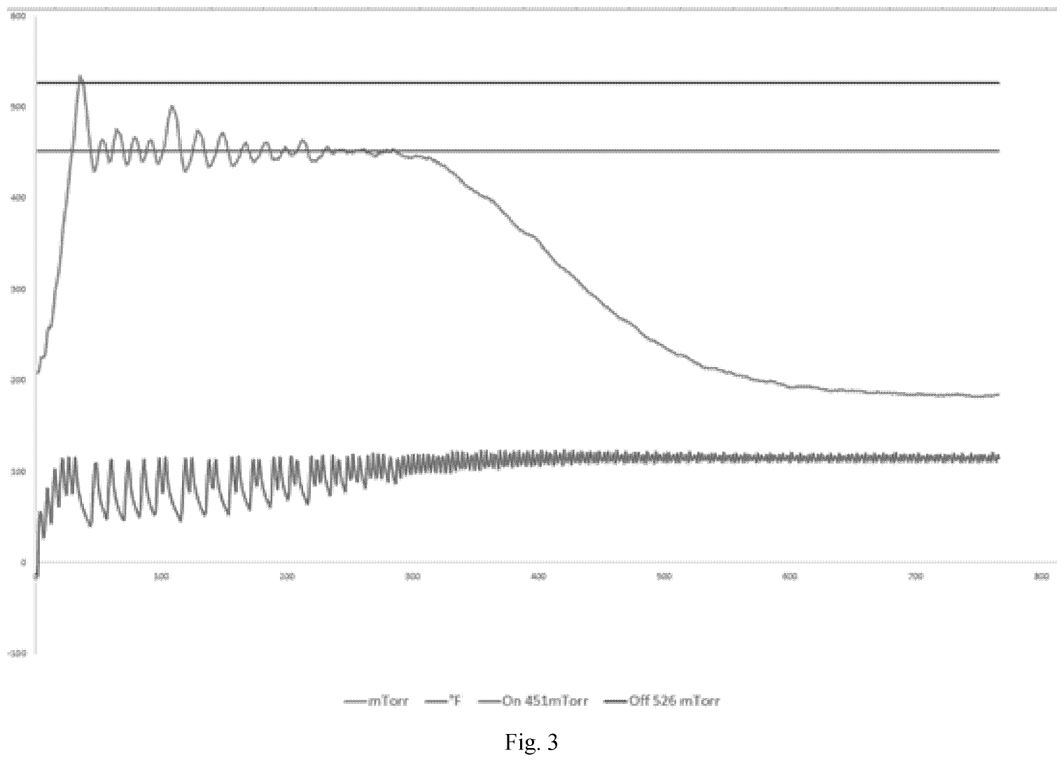

The graph in FIG. 3 is similar to FIG. 2 except it shows a small/low moisture process. The sublimation is not enough to reach 600 mTorr (the markings on the y axis are 100-600 in increments of 100). Whereas the graph in FIG. 2 is simply representative of a standard batch where the heater/sublimation cycles run between 500 mTorr and 600 mTorr. The graph in FIG. 3 is representative of a small/low moisture batch. As shown in the bottom portion of the graph, at the beginning of the heater cycles, the heaters are on a lot in order to drive the pressure (top portion of the graph) above the 500 mTorr line. In order to not melt the core of the food/material, the heater/pressure points are customized to accommodate the material being freeze dried. Again, the heaters are allowed to turn on long enough to cause sublimation of water to in turn cause the chamber pressure to increase to the predetermined level. Then they turn off until the water freezes to the walls of the chamber and the pressure comes down. If the predetermined pressure cannot be reached when the heaters are turned on, the heaters will be turned off when they reach a predetermined temperature (i.e. 125° F. or some other temperature). This is done to continue to dry the product and to keep it from being overheated or burned.

### Initiation of Final Dry Process

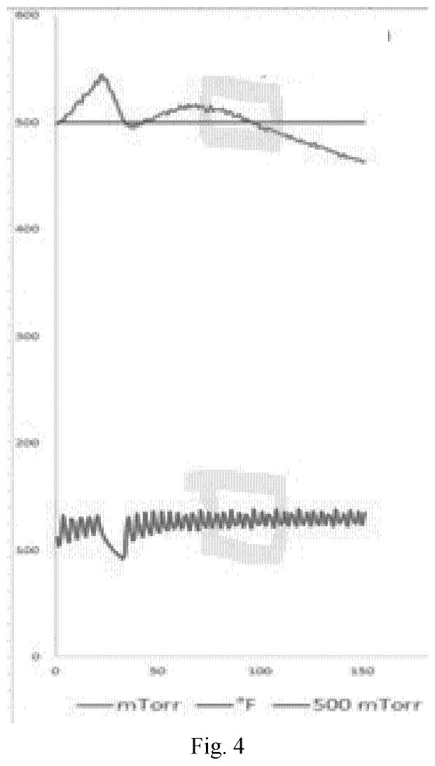

The process can be configured to advance to the final dry portion based on the following: time, temperature, and pressure slope test to ascertain moisture level (this accelerates the drying cycle end time). As shown in the graph in FIG. 4, which shows an enlarged portion of the graph in FIG. 2, there is not much moisture in the material being dried. The portion inside the square shows that no matter how many heater cycles are use, the pressure continues to drop. This is when the system decides that most of the water has been sublimated and it is time to go into the final dry process. The specific criteria for this can vary. In some implementations, the process uses the sublimation range of heaters on at 500 mT and heaters off when the pressure 600 mT. However, toward the end of the drying period there comes a time when the pressure won't reach 600 mT. At that point, the unit goes into final dry whereupon the heaters are allowed to reach a specific temperature (i.e., 125° F. or some other predetermined temperature) then turned off for three minutes (or some other predetermined length of time). This cycle repeats itself until it comes to the end of the Finial Dry process.

### Completion of Final Dry Process

The system records a running average of the vacuum pressure throughout the final dry process. During the final dry process, heat is continuously applied until it reaches a predetermined temperature such as 125 F whereupon it is turned off for three minutes or some other predetermined time. Whereupon the cycle is repeated over and over. As the product approaches being fully dried, sublimation slows. At the point that the moisture is removed from the product and off gassing stops, the vacuum pump will finally no longer be able to reduce the pressure level. Using the running average, the process determines that when the pressure stabilizes at a certain level of tolerance for an extended period time, the process is determined to be complete.

For example, when, over an hour period of time, the average change in pressure is +/−1 mTorr or less the final dry is determined complete and process ends. The controller compares the current average pressure to the average pressure of 30 and 60 minutes prior to the current pressure reading. The table below shows an example of average mTorr pressure readings and status:

TABLE 1

| 60 mins prior | 30 mins prior | Current | Comparison | Status |
|---|---|---|---|---|
| 422 | 380 | 360 | 42~20 | Final Drying |
| 380 | 360 | 348 | 20~12 | Final Drying |
| 315 | 310 | 308 | 5~2 | Final Drying |
| 308 | 306 | 305 | 3~1 | Final Drying |
| 305 | 304 | 304 | 1~0 | Process Complete |

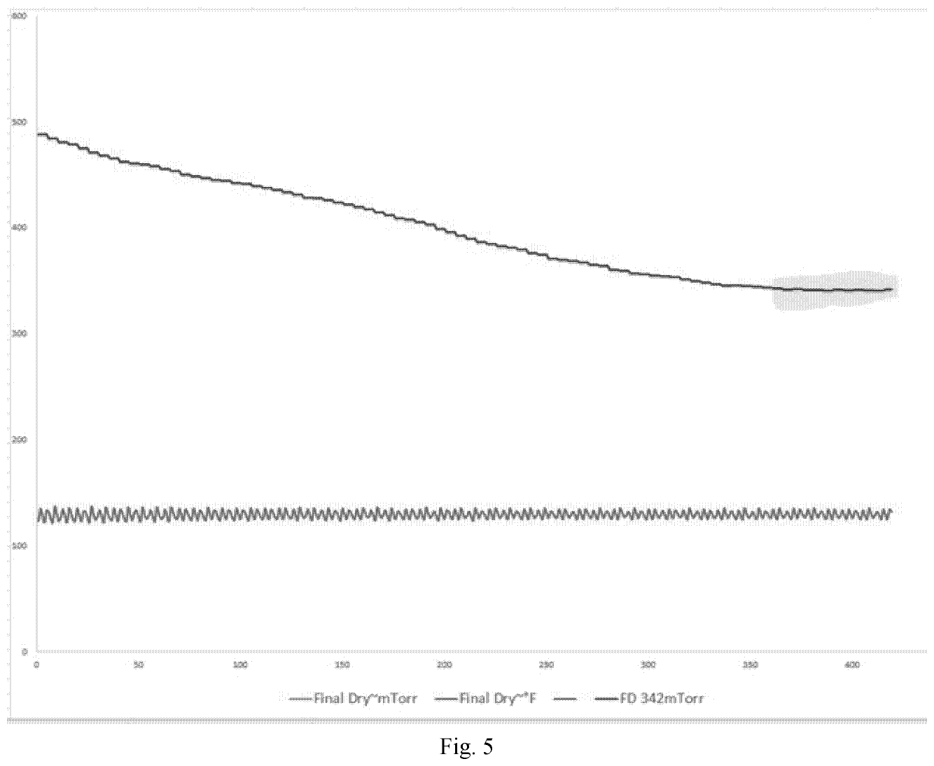

As shown in FIG. 5, the end portion of the upper graph line is highlighted and shows that sublimation is no longer able to cause a significant change in vacuum pressure. It has effectively bottomed out. There is no water left in the food/material being dried. Hence the system ends the process and notifies the user that the material is dry.

### Heater Testing During Drying Process

The system tests for heater functioning throughout the drying and final drying processes (prevents ‘wet’ batches due to heaters not functioning properly). The system checks that the shelf thermistor temperature readings have a minimum of 5° F. rise in temperature each 2-minute period that the heater state is on.

### Heater Relay Failure Testing

The controller can also detect heater relay failure by sensing and measuring the heat of the shelves. If the heater power relay on the controller board is stuck open, the shelf thermistors will detect no heat coming from the heaters. If the heater power relay is stuck closed, the heaters will produce too much heat and may damage the food as well as the unit itself. The criteria for determining too much heat can vary depending on the user. In some implementations, if the temperature of the shelf unit exceeds 135° F. and is still rising it is likely that the heater is in a runaway mode. In these situations, the firmware will send a message to the freeze dryer screen (display) and notify the user of the problem. The system is also capable of shutting off the power to the heaters in the event of a stuck closed relay.

### User Notification of Test Failures

When any of the tests for vacuum, heaters and refrigeration fail, a message is provided to the user on the screen of the freeze dryer. This message lets the user know there is a problem and provides instructions for solving the problem. The instructions help the user solve the identified problem(s) as well as provide directions as to how to find more detailed instructions. Additionally, in most cases a video is provided to solve the problem at hand. During the time that the failure or problem is being reported, the system continues to try to process or resolve the situation(s) while the error messages are displayed on the screen. If the problems are detected as being resolved without human intervention, the messages are automatically removed from the screen and logged/recorded for future analysis. At that time, the process resumes normally.

### General Terminology and Interpretative Conventions

Any methods described in the claims or specification should not be interpreted to require the steps to be performed in a specific order unless expressly stated otherwise. Also, the methods should be interpreted to provide support to perform the recited steps in any order unless expressly stated otherwise.

Certain features described in the context of separate implementations can also be implemented in combination in a single implementation. Conversely, various features that are described in the context of a single implementation can also be implemented in multiple implementations separately or in any suitable subcombination. Moreover, although features may be described above in certain combinations and even initially claimed as such, one or more features from a claimed combination can be excised from the combination, and the claimed combination may be directed to a subcombination or variation of a subcombination.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative implementations where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any implementation, feature, or combination of features described or illustrated in this document. This is true even if only a single implementation of the feature or combination of features is illustrated and described.

### Joining or Fastening Terminology and Interpretative Conventions

The term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The term “coupled” includes joining that is permanent in nature or releasable and/or removable in nature. Permanent joining refers to joining the components together in a manner that is not capable of being reversed or returned to the original condition. Releasable joining refers to joining the components together in a manner that is capable of being reversed or returned to the original condition.

### Computer

It should be appreciated that the present implementations can be provided in the form of an electronic controller and/or control device, which is part of a freeze dryer. The described processes can be implemented in a variety of ways including an entirely hardware implementation, an entirely software implementation (including firmware, resident software, micro-code, etc.), or an implementation combining software and hardware aspects that may all generally be referred to as a “module” or “system.” Furthermore, the present implementations can take the form of a computer program or algorithm contained in any tangible medium of expression having computer-usable program code embodied in the medium.

The controller can include a number of computer related hardware. For example, a computer-readable medium can include one or more of a hard disk, a portable storage device (USB stick), a random-access memory (RAM) device, a read-only memory (ROM) device, an erasable programmable read-only memory (EPROM or Flash memory) device, a portable compact disc read-only memory (CDROM), an optical storage device, a magnetic storage device, and the like. Computer program code for carrying out operations of the present implementations can be written in any combination of one or more programming languages.

The flowchart and block diagrams in the flow diagrams illustrate the architecture, functionality, and operation of possible implementations of systems, methods, and computer program products according to various implementations of the disclosed subject matter. In this regard, each block in the flowchart or block diagrams can represent a module, segment, or portion of code, which comprises one or more executable instructions for implementing the specified logical function(s).

It should be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The term module can refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, can include software, firmware, byte-code and/or microcode, and can refer to programs, routines, functions, classes, and/or objects. The term shared, as used above, means that some or all code from multiple modules can be executed using a single (shared) processor. In addition, some or all code from multiple modules can be stored by a single (shared) memory. The term group, as used above, means that some or all code from a single module can be executed using a group of processors. In addition, some or all code from a single module can be stored using a group of memories.

The techniques described in this document can be implemented by one or more computer programs executed by one or more processors. The computer programs include processor-executable instructions that are stored on a non-transitory tangible computer readable medium. The computer programs can also include stored data. Non-limiting examples of the non-transitory tangible computer readable medium are nonvolatile memory, magnetic storage, and optical storage.

Some portions of the above description present the techniques in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions in the form of an algorithm. It should be noted that the described process steps and instructions could be implemented in software, firmware or hardware, and when implemented in software, could be downloaded to reside on and be operated from different platforms used by real time network operating systems.

The present disclosure also relates to an apparatus for performing the disclosed operations. This apparatus may be specially constructed for the required purposes. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented in this document are not inherently related to any particular computer or other apparatus. Various general-purpose systems may also be used with programs in accordance with the teachings in this document, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described in this document, and any references to specific languages are provided for disclosure of enablement and best mode of the present invention.

The foregoing description has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations are not to be regarded as a departure from the disclosure, and all such modifications are intended to be included within the scope of the disclosure.

### Incorporation by Reference

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.
U.S. Prov. App. No. 63/039,377, titled “Freeze Drying Methods,” filed on 15 Jun. 2020.
U.S. patent application Ser. No. 16/659,259, titled “Freeze-Drying Methods Including Vacuum Freezing,” filed on 21 Oct. 2019.
U.S. Prov. App. No. 62/748,247, titled “Vacuum Freezing Methods and Apparatuses,” filed on 19 Oct. 2018.
U.S. Pat. No. 9,459,044 (application Ser. No. 13/841,251), titled “Freeze Drying Methods and Apparatuses,” filed on 15 Mar. 2013, issued on 4 Oct. 2016.

1. A method for freeze drying food comprising vacuuming freezing the food.

2. The method of claim 1 comprising confirming the operational status of at least one of a pressure sensor, a temperature sensor, a heating system, a cooling system, and/or a vacuum pump.

3. The method of claim 1 comprising performing at least one of pre-frozen or not frozen status check, a chamber pre-freezing process, a vacuum leak check, a drying process, a final dry process, including any of such processes described in the specification.

4. A method for freeze drying food in any of the embodiments of the freeze dryer described in the specification and using any of the processes described in the specification.
